(19) United States
(12) Patent Application Publication
(10) Pub. No.: US 2003/0034960 A1
(43) Pub. Date: Feb. 20, 2003

(54) Coordinates input device and method for the same

(76) Inventor: Hung-Yuan Li, Chung-Ho City (TW)

Correspondence Address: Thorp Reed & Armstrong, LLP, One Oxford Centre, 301 Grant Street, 14th Floor, Pittsburgh, PA, 15219-1425, US

(21) Appl. No.: 09/929,777

(22) Filed: Aug. 14, 2001

(51) Int. Cl. G09G 5/00

(52) U.S. Cl. 345/179

(57) ABSTRACT

A pointing device disposed at a specific position on top of a tablet receives an electromagnetic signal transmitted from the tablet, converts the signal to the digital format, and then sends the digitized signal back to the tablet. The signal transmission process includes signal confirmation to check if the signal received is of the highest intensity. The tablet receiving the digitized signal also has a confirmation process of its own, and then determines the coordinate position of the pointing device placed over the planar surface of the tablet based on the signal data. According to the method mentioned above, the digitized signal transmission between the pointing device and the tablet can be executed with no danger of interference over the coordinate designation signals, and also a number of error-protection measures are incorporated into the system to enhance the system accuracy and stability.

### BACKGROUND OF THE INVENTION

1. Field of the Invention

The present invention pertains to a coordinates input device and its method, in particular, concerning a method of transmitting digitized signals between a pointing device and a tablet that can free the coordinates input device from interference and operator errors.

2. Description of Related Art

A tablet with a pointing device tracking on its planar surface is considered the main coordinates input device in a computer system, as motion of the pointing device can reflect changes of the coordinate position and press buttons on the device can be used for selecting a specific operation. The operating principle behind these actions is multiple sets of transmitter coils and receiver coils are fixed inside the tablet in matrix form, and the pointing device placed over the planar surface of the tablet receives an analog signal transmitted from a transmitter coil, and it then sends back a corresponding analog signal to the receiver coil of the tablet. After receiving the signal returned from the pointing device, the tablet amplifies the signal and asks the internal processor to determine the position of the pointing device based on the signal data, from which the computer can calculate the cursor position on the screen or carry out the action selected. Numerous patents granted in the U.S. and Europe with respect to the coordinates input devices are based on similar operating principles.

However, a number of drawbacks are found with the signal transmission method and which arise between the tablet and the pointing device operating on the principle of electromagnetism previously mentioned.

1. Interference: Bi-directional transmission of electromagnetic signals between the tablet and the pointing device in the open air could be subject to noise interference, resulting in system errors and instability.

2. High power consumption: Since the pointing device has to detect the electromagnetic signal transmitted from the tablet before it can create its own signal, the signal returning to the tablet could be rather weak. The signal transmission between the pointing device and the tablet needs a large current to produce strong signals, in order to make sure the signal transmission is sufficiently stable, thus excessive power is consumed.

In view that the signal transmission between the tablet and the pointing device mentioned above is not very reliable, as it is often affected by interference and consumes a large amount of power, a way to overcome these problems is needed.

### SUMMARY OF THE INVENTION

The main object of the present invention is to provide a coordinates input device that can ensure the signal transmission between a pointing device and a tablet is free from noise interference and has a low power consumption.

To achieve the above-mentioned objects, the design of the coordinates input device has to take into account the following issues:

detecting electromagnetic signals transmitted from a tablet by a pointing device placed over the planar surface of the tablet;

converting the electromagnetic signals to digital signals by the pointing device; receiving digital signals returned from the pointing device by the tablet; transmitting data signals from the pointing device to the tablet; and determining coordinate position signals of the pointing device over the tablet based on the digital signals received, and then transmitting the coordinate position and data signals to a computer.

The actions of sending and receiving signals are carried out by the tablet simultaneously with load modulation. Only a small current is required for the tablet to transmit the signal. The pointing device receives the signal, converts it to the digital format, and then sends the digitized signal back to the tablet, which is then used for determining the position of the pointing device over the tablet and also for calculating the coordinate position on the screen by the computer. The system built under the present invention is power saving and is able to ensure its signal integrity.

After returning the digital signal to the tablet, the pointing device has the task of determining whether the signal received is of the highest intensity, and if the signal is not so, the pointing device will keep on receiving electromagnetic signals transmitted from the tablet, until a signal of the highest intensity has been confirmed.

After receiving the digital signal from the pointing device, the tablet also has the task of determining whether the signal received is of the highest intensity, and it will stop sending the electromagnetic signals only if the strongest signal has been confirmed, and then it will receive the pressure scale signal and press-button status from the pointing device.

The signal is transmitted from the tablet by means of LC resonance, which consumes less power compared to the signal transmission of the conventional tablet.

Other objects, advantages, and novel features of the invention will become apparent from the detailed description when taken in conjunction with the attached drawings.

### BRIEF DESCRIPTION OF THE DRAWINGS

FIG. 1 is a system conceptual diagram of the invention;

FIG. 2 is a circuit diagram of a tablet in accordance with the invention;

FIG. 3 is a circuit diagram of a pointing device in accordance with the invention;

FIG. 4 is a flowchart showing the operation flow of the pointing device; and

FIG. 5 is a flowchart showing the operation flow of the tablet.

### DETAILED DESCRIPTION OF THE PREFERRED EMBODIMENT

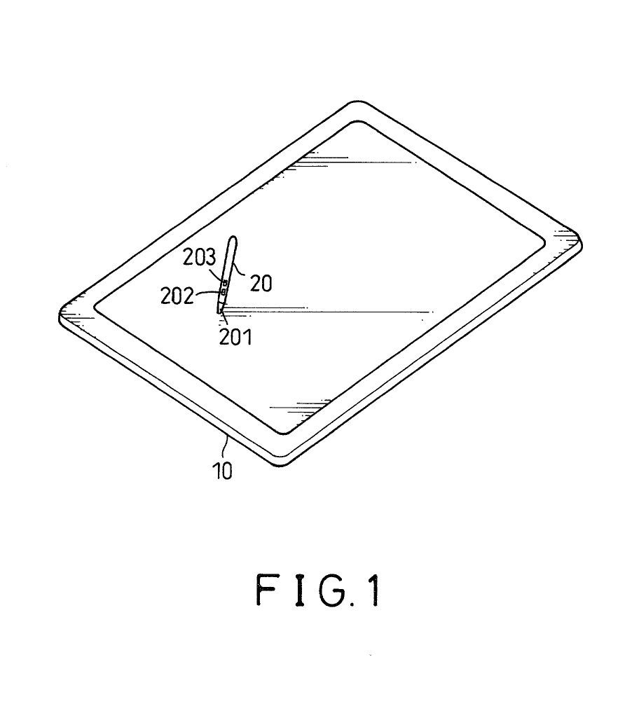

With reference to FIG. 1, there is shown a tablet (10) and a pointing device (20), wherein TX/RX coils (11) are arranged in matrix form on the inside of the tablet (10) for transmitting analog electromagnetic signals to the pointing device (20), and the pointing device (20) is equipped with a pressure sensor (201) and press buttons (202, 203), where the pressure sensor (201) is located on the inside of the pointing device (20) near a tip thereof. When the pointing device receives the electromagnetic signal transmitted by the tablet (10), it converts the signal to a digital format and then returns a digitized signal to the tablet (10), based on which the tablet determines the coordinate position of the pointing device (20).

The internal architectures of the tablet (10) and the pointing device (20) are further illustrated below:

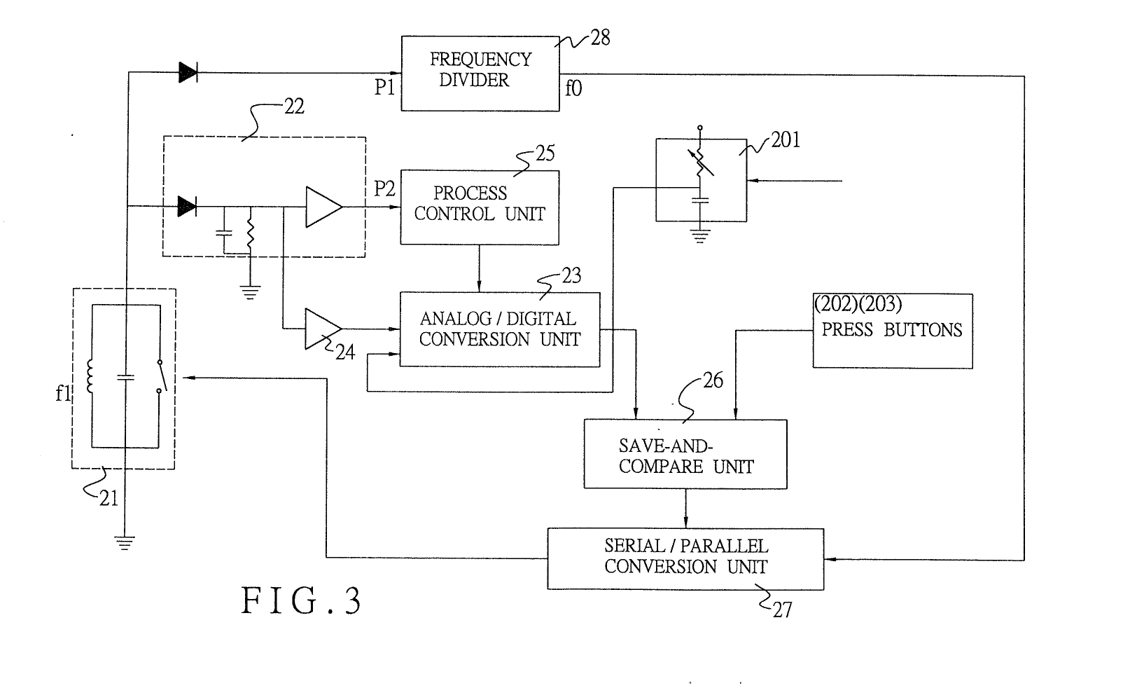

From the diagram of the internal circuit of the pointing device (20) shown in FIG. 3, it is shown that the pointing device mainly comprises a transmitter/receiver antenna set (21), a pulse generator (22), an analog/digital conversion unit (23), a process control unit (25) and a save-and-compare unit (26).

The transmitter/receiver antenna set (21) is a resonance circuit formed with an inductor L1 and a capacitor C1 for receiving analog signals sent by the tablet (10) or sending digitized signals back to the tablet (10), where the inductor L1 could be implemented with fewer turns of wires.

The pulse generator (22) formed with an RC circuit and a comparator, is linked to the output port of the transmitter/receiver antenna set (21), for generating a starting signal based on the signal received from the transmitter/receiver antenna set (21).

The analog/digital conversion unit (23) has one input port connected with the transmitter/receiver antenna set (21) through an amplifier (24), for converting the analog signal received to digital form, and has another input port connected with the pressure sensor (201) for converting the analog pressure scale signal to the digital format.

The process control unit (25) has an input port connected with the output port of the pulse generator (22) to be ‘woken up’ by the output signal, and an output port of the process control unit (25) is connected with the analog/digital conversion unit (23) for controlling the process operation.

The save-and-compare unit (26) has input ports connected with the output port of the analog/digital conversion unit (23) and the press buttons (202, 203) respectively, and its output port is connected with the transmitter/receiver antenna set (21) through a serial/parallel conversion unit (27). A frequency divider (28) is further connected across the transmitter/receiver antenna set (21) and the serial/parallel conversion unit (27).

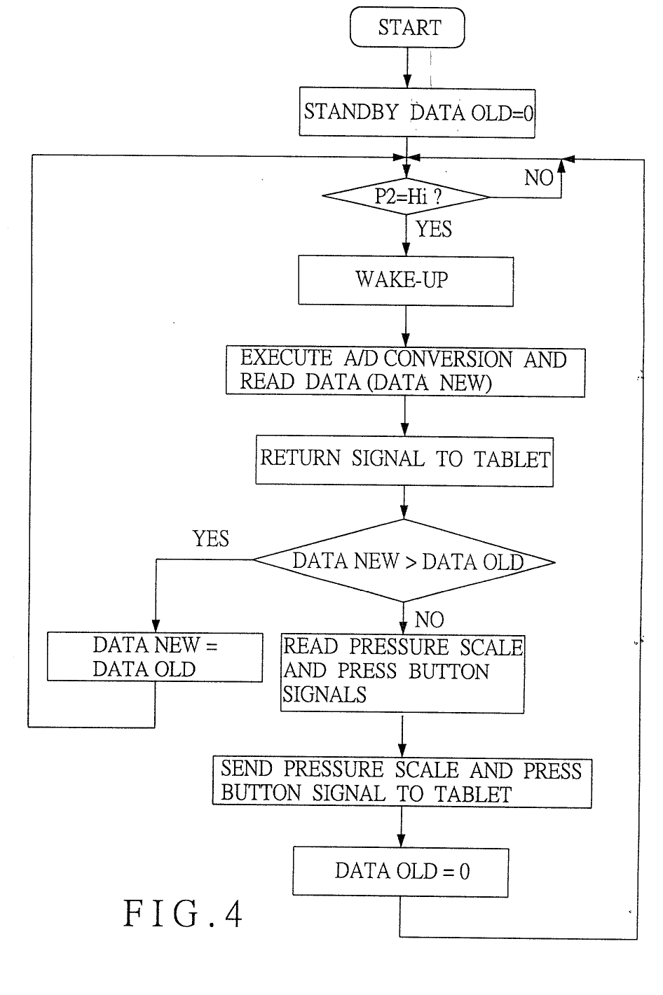

The detailed operations of the above component circuits are illustrated in conjunction with the diagram of process flow in FIG. 4.

When the transmitter/receiver antenna set (21) detects an analog signal from the tablet (10), it forthwith generates a pulse by the pulse generator (22) to wake up the process control unit (25). The transmitter/receiver antenna set (21) through the frequency divider (28) generates a pulse signal to be sent to the serial/parallel conversion unit (27). After processing by the amplifier (24), the transmitter/receiver antenna set (21) then transmits the analog signal to the analog/digital conversion unit (23). The process control unit (25) then asks the analog/digital conversion unit (23) to convert said analog signal from an analog to a digital format creating a new, digital data record (DataNew) which will be saved by the save-and-compare unit (26). The transmitter/receiver antenna set (21), through the action of the serial/parallel conversion unit (27), then transmits the digitized signal back to the tablet (10).

After returning the digitized signal, said save-and-compare unit (26) further determines whether the digitized signal received is of the highest intensity, that is the DataNew value should be greater than the DataOld value (DataNew>=DataOld). If not greater, the save-and-compare unit (26) will continue to receive the electromagnetic signal transmitted from the next set of TX/RX coil (11) of the tablet (10). If a signal of the highest intensity is confirmed, the save-and-compare unit (26) will then receive the signals from the pressure sensor (201) and the press buttons (202, 203).

The operation described above is carried out by the transmitter coils in matrix form installed inside the tablet (10), such that the pointing device (20) over the planar surface of the tablet (10) can detect the signal from multiple transmitter coils nearby. To ensure sufficient level of intensity with the returned signal, a confirmation process is needed to find a signal of the highest intensity, through which the currently received data record (DataNew) is compared with the last data record (DataOld). If DataNew>=DataOld, DataOld will be replaced by DataNew, and then the antenna set will proceed to receive the next data record DataNew and again will compare it with DataOld. If DataNew<=DataOld, that means the previously saved data record DataOld is of the highest intensity, and the save-and compare unit (26) will immediately stop the signal reception transmitted from the tablet (10).

After confirming that the signal received from the tablet (10) is of the highest intensity, said process control unit (25) notifies the analog/digital conversion unit (23) to read off the pressure scale signal from the pressure comparator (201) to be saved by the save-and-compare unit (26). The save-and-compare unit (26) also reads off the press-button status from the press buttons (202) (203), which stands for the functional selection by the user. The save-and-compare unit (26) then transmits the digitized pressure scale signal and press-button status to the tablet (10) going through the path of serial/parallel conversion unit (27) and transmitter/receiver antenna set (21). DataOld is reset to zero, and the above process is repeated.

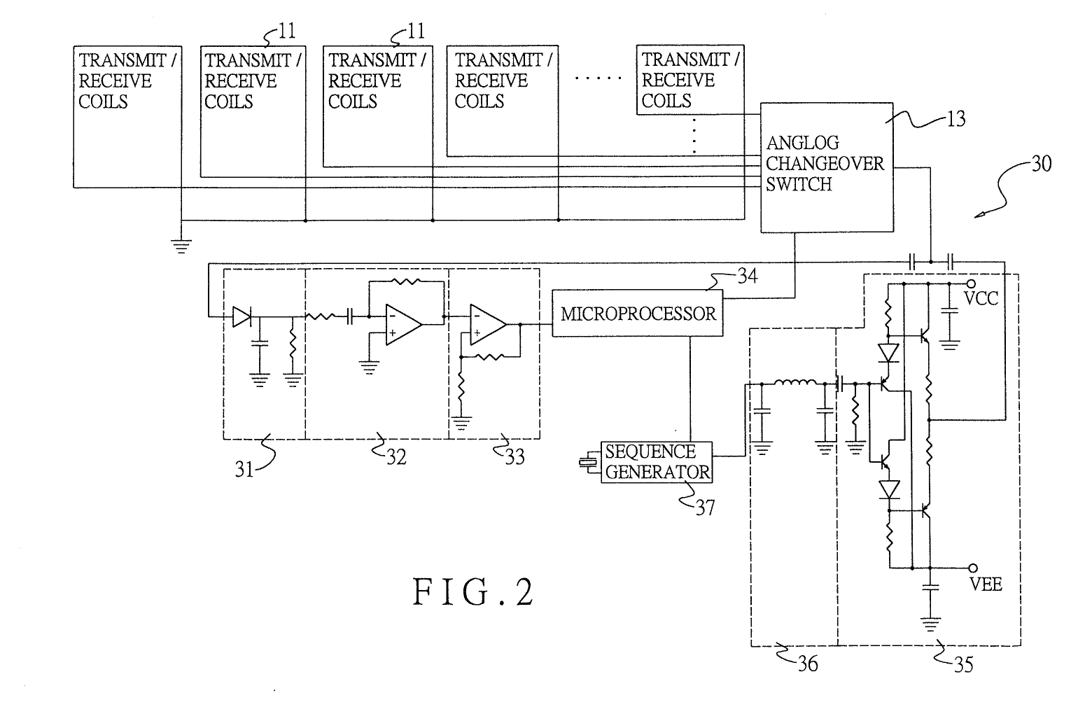

From the diagram of the internal circuit of the tablet (10) in FIG. 2, it is shown that multiple sets of TX/RX coils inside the tablet (10) are connected with a signal transmitter/receiver unit (30) through an analog changeover switch (13) for transmitting analog signals or receiving digitized signals returned from the pointing device (20), where said signal transmit/receive unit (30) comprises a high frequency envelop detector (31), a differential amplifier (32), a magnetic hysteretic comparator (34), a microprocessor (34) and a driver circuit (36).

The high frequency envelop detector (31) is connected with the I/O port of the analog changeover switch (13) through a capacitor for rectifying the digitized signal.

The differential amplifier (32) is installed on the output of the high frequency detector for amplifying the signal.

The magnetic hysteretic comparator (33) is used for confirming the signal output from the differential amplifier (32).

The microprocessor (34) has an input port connected with the I/O port of the analog changeover switch (13) for processing the demodulated signal and sending it to the computer, and has an output port connected with the control port of the analog changeover switch (13) for controlling the transmitting and receiving operations.

The driver circuit (35) has an input port connected with a sequence generator (37) through a filter (36), where the sequence generator (37) is controlled by the microprocessor (34), and the output port of the driver circuit (35) is connected with the I/O port of the analog changeover switch (13) through a capacitor C1.

In the circuit design described above, a microprocessor (34) is used to control the generation of sequence signal by the sequence generator (37). The sequence signal is further processed by the filter (36), then the sequence signal further processed by the driver circuit (35) to generate an analog signal to be sent to the analog changeover switch (13), and then it changes the analog changeover switch (13) thereby allowing the TX/RX coils (11) to transmit analog signals with LC resonance, where L represents the TX/RX coils and C is a capacitor connected across the driver circuit (35) and the analog changeover switch (13). The signal transmission using this method can save more power, as compared with the conventional tablet which directly transmits the signals through the TX/RX coils of the driver circuit.

After the TX/RX coils (11) receive the digitized signal back from the pointing device (20), since the digitized signal from the pointing device (20) has been modulated in the process, the digitized signal has to be demodulated in the process through the actions of the high frequency envelop detector (31), the differential amplifier (32) and the magnetic hysteretic comparator (33) before passing on to the computer.

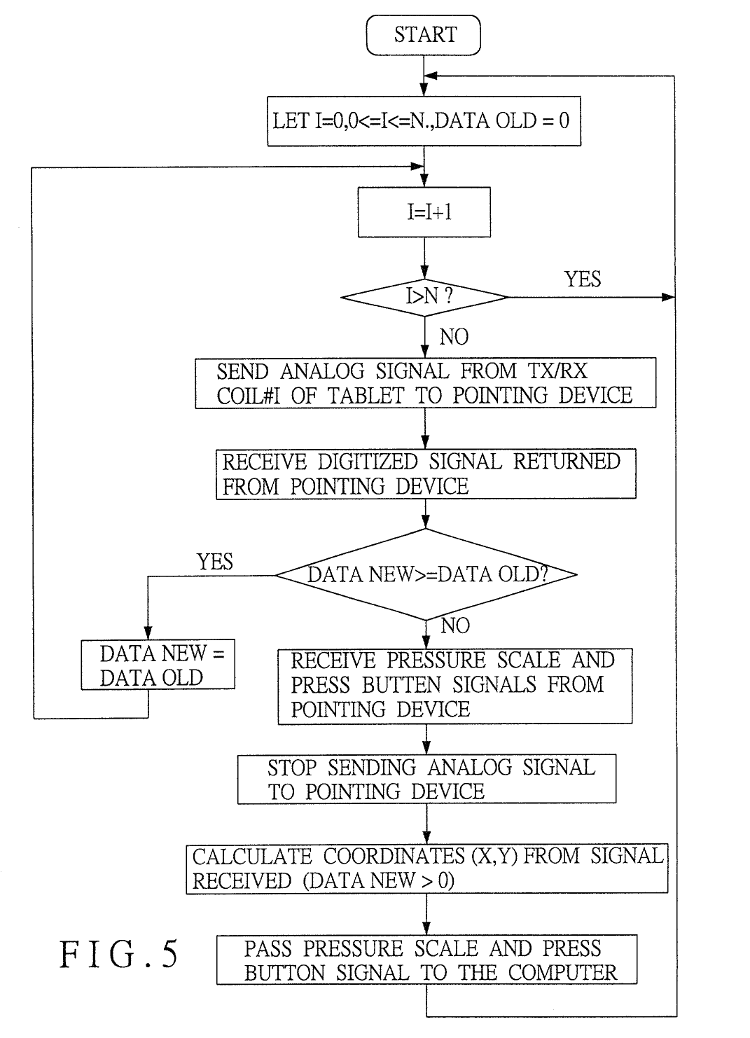

From the diagram of the operation flow of the circuit in FIG. 5, the circuit operation is illustrated in detail as follows. After initialization, DataOld has been reset to zero, and through the action of the analog changeover switch (13) the TX/RX coils (11) are switched over for the transmission of analog electromagnetic signals.

The digitized signal returned from the pointing device (20) is used to determine whether the signal is of the highest intensity through the process of comparing old and new data (DataNew>=DataOld). Through this confirmation it can be assured a signal of the highest intensity has been received.

This confirmation process starts by comparing the currently received data record (DataNew) with the last data record (DataOld); if DataNew>=DataOld, DataOld will be replaced by DataNew, then it continues to receive the next data record (DataNew) and compares it with the previous one (DataOld). If DataNew<=DataOld, it means the previously saved DataOld is a signal received with the highest intensity, and the tablet (13) will then proceed to receive the pressure scale signal and press-button signal from the pointing device (20), and will immediately stop the signal transmission.

Basing on the digitized signal (value greater than zero) received from the pointing device (20), the coordinate position of the pointing device (20) can be determined. The digitized information together with the pressure scale signal and the button press status is then passed to the computer.

In the operation process previously described, since the signal received from the pointing device (20) is in digital format, it can be directly processed by the internal transmit/receive processing unit (30) without the need of conversion. Hence, there is less chance of data corruption in the signal transmission process.

From the foregoing it can be understood that the design of the coordinates input system under the present invention has at least demonstrated the following advantages:

1. High reliability and no interference: Since Q value of the resonance circuit (transmitter/receiver antenna set) of the pointing device is very high, larger current can be produced as compared with the returning of analog signals from the pointing device to the tablet in the conventional method. Since the greater the number of turns on the inductance coils means the risk of interference over the signal transmission is higher, in the present invention, digital signals are transmitted between the pointing device and the tablet, and added to the repeated signal confirmation steps, it is possible to reduce the number of turns on the coil relying on the high Q value of the resonance circuit, which could effectively cut down noise interference.

2. Power saving: Since the resonance circuit of the pointing device is highly sensitive, it only takes a small current from the TX/RX coils of the tablet for the pointing device to produce a current in response. After some internal processing, the pointing device returns a stable and digitized signal, as compared with the conventional tablet requiring large current to drive the analog signals with sufficient intensity.

The signal transmission from the tablet basing on LC resonance circuit requires less power than the signal transmission by conventional tablets, in which the driver circuit is called upon to transmit the signal to the TX/RX coil directly.

It is to be understood, however, that even though numerous characteristics and advantages of the present invention have been set forth in the foregoing description, together with details of the method and function of the invention, the disclosure is illustrative only, and changes may be made in detail, within the principles of the invention to the full extent indicated by the broad general meaning of the terms wherein the appended claims are expressed.

What is claimed is:

1. A method for inputting coordinates into a computer, comprising the acts of:
receiving electromagnetic signals transmitted from a tablet (10) by a pointing device (20);
converting the electromagnetic signals to digital signals by the pointing device (20);
returning the digital signals to the tablet (10) by the pointing device (20);
receiving the digital signals sent back from the pointing device (20) by the tablet (10), and then proceeding with a signal confirmation process;
determining whether the signal received is of the highest intensity with the signal confirmation process by the tablet (10), and then sending out a status signal; and
making use of the digital signals received from the tablet (10) to determine a coordinate position of the pointing device (20) on a planar surface of the tablet (10), and passing the coordinate position and the status signals to the computer.

2. The method as claimed in claim 1, wherein the signal confirmation process of the tablet (10) after receiving the digital signals from the pointing device (20) is used to determine whether the signal is of the highest intensity, and if the signal is not of the highest intensity the pointing device (20) will proceed to receive a subsequent round of electromagnetic signals transmitted by TX/RX coil (11), until the strongest signal has been confirmed.

3. The method as claimed in claim 1, wherein the signal confirmation process of the tablet (10) after receiving the digital signals from the pointing device (20) is to determine whether the signal received is of the highest intensity, and if the signal is confirmed to be of the highest intensity, the tablet (10) will immediately stop the transmission of the electromagnetism signals, and then will proceed to receive the status signal sent by the pointing device (20).

4. The method as claimed in claim 1, wherein the transmission of analog signals and reception of digital signals returned from the pointing device (20) are carried out simultaneously by the tablet (10) using a load modulation.

5. A coordinates input device comprising a pointing device (20) and a tablet (10), wherein the pointing device (20) further comprising:
a transmitter/receiver antenna set (21) for receiving analog signal transmitted by the tablet (10) and sending back digital signals to the tablet (10);
a pulse generator (22) connected with an output port of the transmitter/receiver antenna set (21) for generating a starting signal based on the analog signal received by the transmitter/receiver antenna set (21);
an analog/digital conversion unit (23) wherein a first input port is connected with the transmitter/receiver antenna set (21) through an amplifier (24) for converting the analog signals received to the digital signals;
a process control unit (25) wherein an input port is connected with the output port of the pulse generator (22), and an output port is connected with the analog/digital conversion unit (23); and
a save-and-compare unit (26) wherein an input port is connected with the output port of the analog/digital conversion unit (23) and press buttons (202,203) respectively, and an output port is connected with the transmitter/receiver antenna set (21) through a serial/parallel conversion unit (27).

6. The coordinates input device as claimed in claim 5, wherein a frequency divider (28) is connected across the transmitter/receiver antenna set (21) and the serial/parallel conversion unit (27).

7. The coordinates input device as claimed in claim 5, wherein the transmitter/receiver antenna set (21) is formed with an inductor L1 and a capacitor C1 forming an LC resonance circuit.

8. The coordinates input device as claimed in claim 5, wherein the pulse generator (22) is formed with a comparator and an RC circuit.

9. The coordinates input device as claimed in claim 5, wherein a second input port of the analog/digital conversion unit (23) is connected with a pressure sensor (201).

10. The coordinates input device as claimed in claim 5, wherein multiple sets of transmitter/receiver antennas (11) are installed inside the tablet (10) and connected with a signal transmit/receive unit (30) through an analog changeover switch (13), the signal transmit/receive unit (30) comprising:
a high frequency envelop detector (31) connected with an I/O port of the analog changeover switch (13) through a capacitor so that the digital signals received by the TX/RX coil (11) can undergo a rectification process;
a differential amplifier (32) installed on an output port of the high frequency envelop detector (31) for the purpose of signal amplification;
a magnetic hysteretic comparator (33) for confirmation of the signal output from the differential amplifier (32);
a microprocessor (34) wherein the input port is connected with the I/O port of the analog changeover switch (13), and a control port connected with the control port of the analog changeover switch (13) for controlling the switching between transmitter and receiver modes; and
a driver circuit (35) wherein the input port is connected with a sequence generator (37) through a filter (36), where the action of the sequence generator (37) is controlled by the microprocessor (34), and the output port is connected with the I/O port of the analog changeover switch (13) through a capacitor.

11. The coordinates input device as claimed in claim 5, wherein a capacitor is connected across the TX/RX coils (11) and the signal transmit/receive unit (30) of the tablet (10) forms an LC resonance circuit for signal transmission.

12. The coordinates input device as claimed in claim 6, wherein the transmitter/receiver antenna set (21) is formed with an inductor L1 and a capacitor C1 forming an LC resonance circuit.

13. The coordinates input device as claimed in claim 12, wherein the pulse generator (22) is formed with a comparator and an RC circuit.

14. The coordinates input device as claimed in claim 13, wherein a second input port of the analog/digital conversion unit (23) is connected with a pressure sensor (201).

15. The coordinates input device as claimed in claim 12, wherein multiple sets of transmitter/receiver antennas (11) are installed inside the tablet (10) and connected with a signal transmit/receive unit (30) through an analog changeover switch (13), the signal transmit/receive unit (30) comprising:
a high frequency envelop detector (31) connected with an I/O port of the analog changeover switch (13) through a capacitor so that the digital signals received by the TX/RX coil (11) can undergo a rectification process;
a differential amplifier (32) installed on an output port of the high frequency envelop detector (31) for the purpose of signal amplification;
a magnetic hysteretic comparator (33) for confirmation of the signal output from the differential amplifier (32);
a microprocessor (34) wherein the input port is connected with the I/O port of the analog changeover switch (13), and a control port connected with the control port of the analog changeover switch (13) for controlling the switching between transmitter and receiver modes; and
a driver circuit (35) wherein the input port is connected with a sequence generator (37) through a filter (36), where the action of the sequence generator (37) is controlled by the microprocessor (34), and the output port is connected with the I/O port of the analog changeover switch (13) through a capacitor.

16. The coordinates input device as claimed in claim 13, wherein multiple sets of transmitter/receiver antennas (11) are installed inside the tablet (10) and connected with a signal transmit/receive unit (30) through an analog changeover switch (13), the signal transmit/receive unit (30) comprising:
a high frequency envelop detector (31) connected with an I/O port of the analog changeover switch (13) through a capacitor so that the digital signals received by the TX/RX coil (11) can undergo a rectification process;
a differential amplifier (32) installed on an output port of the high frequency envelop detector (31) for the purpose of signal amplification;
a magnetic hysteretic comparator (33) for confirmation of the signal output from the differential amplifier (32);
a microprocessor (34) wherein the input port is connected with the I/O port of the analog changeover switch (13), and a control port connected with the control port of the analog changeover switch (13) for controlling the switching between transmitter and receiver modes; and
a driver circuit (35) wherein the input port is connected with a sequence generator (37) through a filter (36), where the action of the sequence generator (37) is controlled by the microprocessor (34), and the output port is connected with the I/O port of the analog changeover switch (13) through a capacitor.

17. The coordinates input device as claimed in claim 14, wherein multiple sets of transmitter/receiver antennas (11) are installed inside the tablet (10) and connected with a signal transmit/receive unit (30) through an analog changeover switch (13), the signal transmit/receive unit (30) comprising:
a high frequency envelop detector (31) connected with an I/O port of the analog changeover switch (13) through a capacitor so that the digital signals received by the TX/RX coil (11) can undergo a rectification process;
a differential amplifier (32) installed on an output port of the high frequency envelop detector (31) for the purpose of signal amplification;
a magnetic hysteretic comparator (33) for confirmation of the signal output from the differential amplifier (32);
a microprocessor (34) wherein the input port is connected with the I/O port of the analog changeover switch (13), and a control port connected with the control port of the analog changeover switch (13) for controlling the switching between transmitter and receiver modes; and
a driver circuit (35) wherein the input port is connected with a sequence generator (37) through a filter (36), where the action of the sequence generator (37) is controlled by the microprocessor (34), and the output port is connected with the I/O port of the analog changeover switch (13) through a capacitor.

18. The coordinates input device as claimed in claim 15, wherein a capacitor is connected across the TX/RX coils (11) and the signal transmit/receive unit (30) of the tablet (10) forms an LC resonance circuit for signal transmission.

19. The coordinates input device as claimed in claim 16, wherein a capacitor is connected across the TX/RX coils (11) and the signal transmit/receive unit (30) of the tablet (10) forms an LC resonance circuit for signal transmission.

20. The coordinates input device as claimed, in claim 17, wherein a capacitor is connected across the TX/RX coils (11) and the signal transmit/receive unit (30) of the tablet (10) forms an LC resonance circuit for signal transmission.
